(19) United States
(12) Patent Application Publication
(10) Pub. No.: US 2017/0085357 A1
(43) Pub. Date: Mar. 23, 2017

(54) DEVICES, SYSTEMS, AND METHODS FOR SYNCHRONIZATION OF BROADBAND WIRELESS COMMUNICATION SYSTEMS

(71) Applicant: Ful Spectrum Inc., Sunnyvale, CA (US)

(72) Inventor: Menashe Shahar, Los Altos, CA (US)

(21) Appl. No.: 15/182,242

(22) Filed: Jun. 14, 2016

Related U.S. Application Data
(60) Provisional application No. 62/193,837, filed on Jul. 17, 2015.

(51) Int. Cl. H04L 5/14; H04W 56/00

(52) U.S. Cl. CPC H04L 5/14; H04W 56/001

(57) ABSTRACT

Methods for synchronization of a time division duplex (TDD) frame at a remote station are provided. A remote station receives a time division duplex (TDD) frame from a base station The remote station determines a propagation delay between the remote station and the base station. The remote station synchronizes the TDD frame to a 1 PPS signal derived from a GPS module located at the remote station plus the propagation delay.

### CROSS REFERENCE TO RELATED APPLICATIONS

This Application claims the benefit of U.S. provisional patent application 62/193,837, filed on Jul. 17, 2015, the entire contents of which are owned by the assignee of the instant application and incorporated herein by reference it is entirety.

### FIELD OF THE INVENTION

The invention relates generally to Point to Multipoint (PtMP) Broadband Wireless Systems having Base Stations (BSs) and Remote fixed and mobile Stations (RSs). In particular, the invention relates to Time Division Duplex (TDD) synchronization between BSs and RSs.

### BACKGROUND

Point to Multipoint (PtMP) Broadband Wireless Systems can include base stations (BS), remote stations (fixed or mobile) (RS) for example, to provide broadband access to multiple users per BS. Every BS can communicate with one or more RSs that are located at varying distances from the BS. The BS to which a RS is connected can be referred to as its parent BS. A BS with all RSs connected to it can be referred to as a sector.

BSs and RSs communication can employ a time division duplex (TDD) scheme. The TDD frames can consist of multiple sections, for example, a Downlink Sub Frame (DLSF), an Uplink Sub Frame (ULSF), a Transmit to Receive Gap (TRG), a Receive to Transmit Gap (RTG), or any combination thereof. Transmissions from the BSs to RSs are typically done within the DLSF and transmissions from the RSs to BSs are typically done within ULSF. The start of the TDD frame can be synchronized between all BSs. This can be done by, for example, by synchronizing the beginning of the TDD frame to a 1 PPS signal from a GPS module.

Communication from a BS and a RS can include a preamble signal, which the BS can transmit in the first symbol of the DLSF. The preamble can be used by the RS to derive time and frequency synchronization. Time synchronization can include TDD frame synchronization (e.g., identify the beginning of the TDD frame) and sampling clock synchronizations. Frequency synchronization can refer to the center RF frequency and subcarrier frequencies in the case of a multicarrier system. The preamble can be modulated according to a modulation scheme (e.g., binary phase-shifting keying (BPSK), quadrature phase-shifting keying (QPSK), higher order quadrature amplitude modulator (QAM), or any combination thereof). The preamble is typically boosted in power relative to the power used for data transport between the BS and the RS. For example, the transmission of the preamble can be boosted in power by 9 dB relative to the data transport transmission.

Boosting the power of the preamble relative to data transport can have undesirable effects. For example, a base station can transmit at a maximum power allowed by a regulatory body and/or at a maximum power supported by a power amplifier of the base station. Boosting the power of the preamble relative to the data transport results in the base station transmit power during data transport being lower than the maximum power allowed/possible which affects the communication range and/or speed of transmission of the data transport.

PtMP Broadband Wireless Systems can employ Orthogonal Frequency Division Multiple Access (OFDMA), such that there are two dimensions, frequency and time. The frequency domain can include multiple carriers. The time domain can be divided into OFDMA symbols.

An OFDMA symbol can include all eligible subcarriers used in the respective OFDMA scheme and/or one or more subsets of all eligible subcarriers (e.g., sub-channel”). Exemplary subcarriers include 128, 512, and/or 1024 sub-carriers. An example of a subset of all eligible subcarriers for a sub-channel are 18 subcarriers.

The BS can transmit the preamble to the RSs within a single OFDMA symbol. The BS can transmit the preamble with a number of modulated subcarriers, for example, larger than the number of subcarriers used for data transport. For example, the system may employ 18 subcarriers for data transport and 33 sub-carriers for the preamble. A larger number of modulated subcarriers for the preamble can reduce the likelihood of preamble detection false alarms. However, a non-even use of subcarriers for the preamble and for the data transport can results in a non-efficient use of the spectrum during the data transport.

Transmitting the preamble to the RS can require subcarriers that are not needed for data transmission to be used. Thus, requiring additional resources for transmission of the preamble to the RS.

The quality of the frequency and time estimation as derived from the preamble by the RS can degrade as the path loss becomes more challenging resulting in, for example, estimation errors and high jitter.

Another difficulty is a race condition that can occur between two types of corrections, namely: i) time ranging corrections measured by the BS and sent by the BS to the RS when the RS transmit signal is not time aligned properly at the BS receiver, and ii) time and frequency corrections derived from the preamble by the RS. The race condition can be a result of the propagation delay between BS and RS, e.g., the beginning of the TDD frame as perceived by the RS at the time of receiving the ranging correction from the BS is different from the time the BS made the time error measurement. The error is likely to increase as the distance increases. In the case of a mobile RS, the distance/propagation delay can change for a given RS, while the above process takes place which further degrades performance.

Therefore, it is desirable to accurately synchronize a RS to a BS without the use of a preamble in the BS transmission.

### SUMMARY OF EMBODIMENTS OF THE INVENTION

One advantage of the invention is accurate TDD frame synchronization at an RS by, for example, deriving the TDD frame timing from a local independent GPS based 1 PPS signal.

Another advantage of the invention is substantial elimination of estimation error and/or jitter. Another advantage of the invention is that it can allow sampling clock synchronization of a RS that is independent from a BS thus, substantially avoiding the need for sampling clock synchronization at the RS with the associated error.

Another advantage of the invention is that it can allow an RS independent computation of a Receive to Transmit Gap (RTG) to properly align its transmission in time such that the signal transmitted by all RSs, reaches the BS at the same time, independent of their distance.

Another advantage of the invention is that the removal of the preamble can allow the BS to transmit the data at a higher power (e.g., the maximum power allowable by a regulatory body and/or the maximum power allowable by the particular BS).

Another advantage of the invention is that the removal of the preamble can allow the improvement of spectral utilization due to, for example, availability of the entire spectrum for data transmission.

In one aspect, the invention involves a method for synchronization of a time division duplex (TDD) frame in a remote station from a base station. The method involves receiving a base station signal from the base station, the base station signal encapsulated in the TDD frame. The method involves determining a propagation delay of the base station signal from the base station to the remote station. The method involves determining a start time of the TDD frame at the remote station based on a 1 pulse per second (PPS) signal of a global positioning system (GPS) module located at the remote station and the propagation delay to the remote from the base station.

In some embodiments, determining the propagation delay involves determining a differential distance between a location of the remote station and a location of the base station based on a downlink channel descriptor (DCD) message in the TDD frame and coordinates of the remote station obtained from the GPS module and translating the differential distance into the propagation delay.

In some embodiments, the method involves receiving a frequency value that indicates a frequency at which the propagation delay is determined. In some embodiments, the frequency value is based on whether the remote station is fixed or mobile. In some embodiments, the frequency value is based on a speed of the remote station.

In some embodiments, the frequency value is set such that the propagation delay is less than or equal to 1 basic sample clock of the GPS. In some embodiments, the method involves setting a sampling clock of the remote station to a frequency derived from a clock provided by the GPS module. The GPS provided clock frequency, e.g., 10 MHz clock, can be synchronized to the 1 PPS signal produced by the GPS module, e.g., it has 10,000,000 cycles between every successive 1 PPS pules.

In some embodiments, the method involves setting a sampling clock of the base station to a frequency derived from a clock provided by the GPS module. The UPS provided clock frequency, e.g., a 10 MHz clock, can be synchronized to the 1 PPS signal produced by the GPS module, e.g., it has 10,000,000 cycles between every successive 1 PPS pules.

In some embodiments, the method involves deriving the sampling clock and RF frequency of the base station from a GPS module located at the base station. GPS. If both BS and RS derive the sampling clock from a GPS module, if both the BSs and the RSs derive their sampling clock and RF frequency from GPS modules, the sampling clock and RF frequency error between BS and RSs can be substantially zero or zero. In some embodiments, no frequency and sampling clock estimation is needed at the remotes.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a diagram of an exemplary wireless system, according to an illustrative embodiment of the invention.

FIG. 2 is a flow diagram illustrating a method for synchronization of a remote station, according to an illustrative embodiment of the invention.

### DETAILED DESCRIPTION OF EMBODIMENTS OF THE INVENTION

Generally, data is transmitted to/from a BS to RSs is encapsulated in TDD frames. Each TDD frame includes a Downlink Sub Frame (DLSF) in which the BS may transmit to the RSs and an Uplink Sub-Frame in which the RSs may transmit to the BS. The BS aligns the start time of the DLSF with a 1 PPS pulse obtained from a GPS module located at the BS site. The BS can perform alignment of the start of the TDD frame at a frequency, for example, once per second if the number of TDD frames per second is integer or every couple of seconds if the TDD frame per second is not an integer. The alignment can occur with a frequency that allows the TDD synchronization period to equal an integer number of TDD frames.

The RSs aligns the start time of the DLSF delayed replica of a 1 PPS signal derived from a GPS module located at the RSs. The delay is equal to a one way propagation delay from the BS to the RS. The propagation delay between the BS and the RS is determined based on the distance between the BS and the RS.

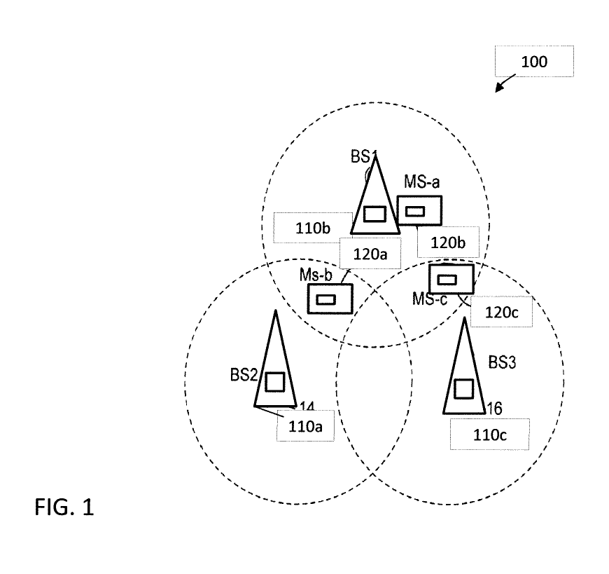

FIG. 1 is a diagram of an exemplary wireless system 100, according to an illustrative embodiment of the invention. The wireless system 100 includes base stations 110a, 110b, 110c, generally, 110, and remote stations 120a, 120b, 120c, generally 120. Each of the base stations 110 includes a corresponding GPS module 112a, 112b, 112c, generally, 112. Each of the remote stations 120 includes a corresponding GPS module, 122a, 122b, 122c, generally, 122.

It will be understood that remote stations may be fixed or mobile remote stations. It will further be understood that one or more BS 110 may reside in a single tower.

The exemplary wireless system 100 can be configured in accordance with one or more industry standard protocols (e.g., Institute of Electrical and Electronics Engineers (IEEE) 802.16, 802,16e) as is known in the art. The exemplary wireless system 100 can be a WIMAX system, LTE system, or any other broadband system as is known in the art. It is to be understood that the invention is not limited to operating within the standard protocols as are currently available. Updates, modifications, and new protocols can be used in communication systems that include BSs and RSs without affecting the ability of a communication system to practice the invention.

The base stations (BSs) 110 can communicate with the remote stations (RSs) 120. The communication from the BSs 110 to the RSs 120 can be referred to as a downlink. The communication from the RSs 120 to the BSs 110 can be referred to as an uplink.

The BSs 110 and/or the RSs 120 can include a GPS synchronized clock as a reference to its respective sampling clock and/or TDD framing.

Any of the BSs 110 can communicate with any of the RSs 120 within a service area of the particular BSs 110. Transmission between the BSs 110 and the RSs 120 can be done in according with TDD framing. TDD framing in each of the BSs 110 can have a start time that is aligned its respective GPS module's 1 PPS signal. Messages from the BSs 110 can include geographical coordinates of the particular BSs that transmitted the message. The coordinates can be included by the BSs in a Downlink Channel Descriptor (DCD) message.

Each RSs 120 can derive its respective sampling close and TDD frame start time from its respective GPS module 122.

Upon receipt of a message that includes BS location coordinates information, the RSs 120 can obtain the geographical coordinates of the particular BSs 110 that transmitted the message. The RSs 120 can also obtain its own coordinates and derive the 1 PPS signal from its respective GPS module 122. The RSs 120 can determine a propagation delay based on the geographical coordinates of the particular BSs 110 and its own coordinates. The RSs can determine its TDD start time based on the 1 PPS signal and the propagation delay. The TDD frame start time can be determined by adding the propagation delay to the 1 PPS Pulse.

In this manner, the RSs 120 can avoid relying on the BSs 110 preamble to derive TDD farming.

In some embodiments, one or more of the BSs 110 can each serve as an access point to one or more of the RSs. In some embodiments, one of the BSs 110 can serve as an access point to all RSs 120 that are in the same sector. Two way communications can be established between the one BS and all RSs 120 in the same sector. Transmission within a sector can be fully controlled by the sector's BS. RSs 120 can transmit in the uplink direction upon receipt of an allocation of “air resource” from the BS.

The wireless system 100 can employ Orthogonal Frequency Division Multiple Access (OFDMA), such that there are two dimensions, frequency and time. The frequency domain can include multiple carriers. The time domain can be divided into symbols.

The eligible subcarriers within a sector can be all subcarriers used in the respective OFDMA scheme and/or one or more of a subset of all subcarriers (e.g., “sub-channel”). Exemplary OFDMA schemes include 128, 512, and/or 1024 sub-carriers.

The wireless system 100 can employ Time Division Duplex (TDD). The time domain can be partitioned into TDD frames. The TDD frames can consist of sections, for example, a Downlink Sub Frame (DLSF), an Uplink Sub Frame (ULSF), a Transmit to Receive Gap (TRG), a Receive to Transmit Gap (RTG), or any combination thereof.

Duration of each section of the TDD frame can be configurable. The TDD configuration can be based on traffic characteristics, latency and/or distance.

Traffic Characteristics: for a symmetrical traffic application (e.g., Voice over Internet Protocol), the DLSF and the ULSF can have an equal duration. For an asymmetrical traffic application (e.g., web browsing), the DLSF can be large and the ULSF can be small (e.g., a DLSF duration of 8 milliseconds and a ULSF duration is 2 milliseconds). For a reverse asymmetrical traffic application e.g., web hosting, the DLSF can be small and the ULSF can be large.

Latency: overall frame duration of a TDD frame can be configured based on latency requirements. The shorter the latency requirement, the smaller the frame duration. As the frame duration is reduced, the overhead (e.g., the bandwidth required for transmission of non-data information, for example, the preamble) increases due to, for example, an increase in per frame overhead percentage and/or increase in fragmentation of long packets.

Distance: the Receive to Transmit Gap (RTG) at each RS 120 can exceed the Round Trip Delay (RT) from the BS 110 to any RS 120 in the BS 110 coverage area plus the receive-to-transmit switching delay at the RS 120. The value of the Transmit to Receive Gap (TRG) at the BS 110 can be based on the TRG. The TRG and RTG can be configured statically at the BS 110, by for example, being read from memory as input by a user. The RTG and TRG at the RSs 120 can be determined dynamically. The RTG and TRG at each RSs 120 can be determined using a closed loop time ranging handshake mechanism involving the BS 110 and the RS 120 based on BS 110 to RS 120 as in known in the art. The RTG and TRG at each RSs 120 can be determined using a respective GPS modules 122 based mechanism at the RS 120.

In some embodiments, the TDD frame is configured identically in all of the BSs 110 and the RSs 120, to for example, avoid interference.

In some embodiments, interference caused by the transmissions of one sector to the receiver of another sector in the tower is substantially reduced once all sectors in the tower employ the same TDD frame structure and all sectors in the tower are TDD synchronized to the 1 PPS pulse.

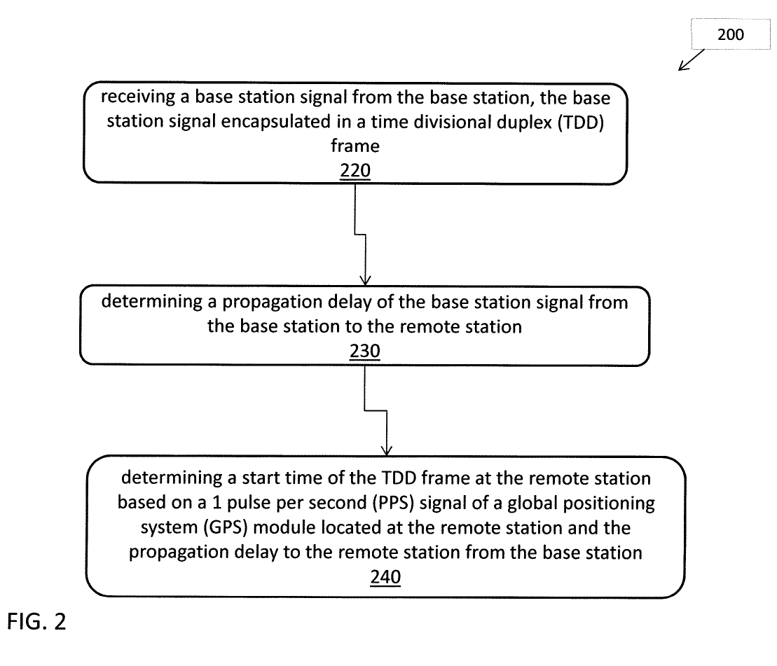

FIG. 2 is a flow diagram 200 illustrating a method for synchronization of a remote station (e.g., RS as described above in FIG. 1), according to an illustrative embodiment of the invention. The method involves receiving a base station signal from BS, the base station signal encapsulated in a TDD frame (Step 220).

The method also involves determining a propagation delay of the base station signal from the BS to the RS (Step 230). The propagation delay can be determined based on coordinates as measured by the GPS module at the RS and the BS. The BS coordinates can be transmitted by the BS to all RSs in the BS sector within the Downlink. Channel Descriptor (DCD) message.

The method also involves determining a start time of the TDD frame at the remote station based on a 1 pulse per second (PPS) signal of a global positioning system (GPS) module located at the RS and the propagation delay to the RS from the BS (Step 240).

The propagation delay can be determined based on a differential distance between a location (e.g., geographical coordinates) of the remote station, as is available a GPS module located at the remote station (e.g., GPS 122 as described above in FIG. 1) and a location of the base station (e.g., geographical coordinates), as is available in the downlink channel descriptor (DCD) message in the TDD frame. The differential distance between the location of the remote station and the location of the base station can be determined as is known in the art.

The differential distance can be translated into a Round Trip Delay (RTD), for example, RTD μs equals 2 times the differential distance in miles/0.1863 miles per μs. RTD in μs can be converted to samples depending on the basic sampling clock rate. For example, operation within a 1 MHz wide channel can be done with a sampling clock rate of 1.12 MHz. In this example, the sample duration is 0.893 μs. RTD for a 10 mile distance is 107 μs, which is 120 samples.

The method can also involves determining a synchronization start time of the TDD frame based on a 1 pulse per second (PPS) signal of a global positioning system (GPS) module and the propagation delay. The start time of the TDD frame at the RS is delayed relative to the start time of the TDD frame at the BS by the propagation delay.

In some embodiments, a frequency at which the propagation delay is determined is configurable. In some embodiments, the configurable frequency is based on whether the RS is fixed or mobile and/or the speed of mobility of the RS.

In some embodiments, the frequency at which the propagation delay is determined is based on achieving a propagation delay accuracy within 1 basic sample clock. For example, in the case of mobile RS, if the sampling clock frequency is 1.12 MHz, the duration of 1 sample is 0.893 μs. One sample difference will happen when the RS travelled about 80 meter from the previous position. If the RS is traveling at a speed of 60 km/hr., the measurement frequency can be done at about every 4 seconds.

In some embodiments, the RS can determine a round trip delay (RTD) to the BS based on the differential distance. In these embodiments, the RS can transmit to the BS at BS TRG-RTD after the end of a DLSF.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for synchronization of a time division duplex (TDD) frame in a remote station from a base station, the method comprising:
receiving a base station signal from the base station, the base station signal encapsulated in the TDD frame;
determining a propagation delay of the base station signal from the base station to the remote station; and
determining a start time of the TDD frame at the remote station based on a 1 pulse per second (PPS) signal of a global positioning system (GPS) module located at the remote station and the propagation delay to the remote station from the base station.

2. The method of claim 1 wherein determining the propagation delay further comprises:
determining a differential distance between a location of the remote station and a location of the base station based on a downlink channel descriptor (DCD) message in the TDD frame and coordinates of the remote station obtained from the GPS module; and
translating the differential distance into the propagation delay.

3. The method of claim 1 further comprising:
receiving a frequency value that indicates a frequency at which the propagation delay is determined.

4. The method of claim 3 wherein the frequency value is based on whether the remote station is fixed or mobile.

5. The method of claim 3 wherein the frequency value is based on a speed of the remote station.

6. The method of claim 3 wherein the frequency value is set such that the propagation delay is less than or equal to 1 basic sample clock of the GPS.

7. The method of claim 1 further comprising:
setting a sampling clock of the remote station to a frequency derived from a clock provided by the GPS module.

8. The method of claim 1 further comprising:
setting a sampling clock of the base station to a frequency derived from a clock provided by the GPS module.
